(19) United States
(12) Patent Application Publication
(10) Pub. No.: US 2007/0223441 A1
(43) Pub. Date: Sep. 27, 2007

(54) Method And Device For The Concurrent Operation Of At Least Two Wireless Link Paths

(75) Inventors: Frank Exeler, Rheine (DE); Anton Kruk, Hamminkeln (DE); Jurgen Voigt, Bocholt (DE)

Correspondence Address: BELL, BOYD & LLOYD, LLP, P.O. BOX 1135, CHICAGO, IL, 60690, US

(73) Assignee: SIEMENS AKTIENGESELLSCHAFT, München (DE)

(21) Appl. No.: 11/568,503

(22) PCT Filed: Mar. 2, 2005
(86) PCT No.: PCT/EP05/50913

§ 371 Date: Oct. 30, 2006

(30) Foreign Application Priority Data
Apr. 30, 2004 (DE) 10 2004 021 342.9

(51) Int. Cl. H04J 3/16; H04Q 7/00

(52) U.S. Cl. 370/345

(57) ABSTRACT

The present disclosure relates to the concurrent operation of at least two wireless link paths. At least one first link path has a first digital transmission method and at least one second link path has a second digital transmission method. The carrier frequencies of these transmission methods lie in frequency bands that at least overlap. The transmission methods transmit, in defined frame and slot cycles, data in a sequence of frames subdivided into a plurality of slots. The frame and/or slot cycles of the transmission methods have different durations. The first transmission method is isochronous. The signal fields of the link paths overlap in such a manner that at the site of at least one receiver of a link path signals originating from two different transmission methods can be received. The slot events of the second transmission method are dynamically distributed to the slots available in the second transmission method depending on slot events of the first transmission method. The disclosure also relates to a transmitter which comprises a slot allocation device and to a receiver which comprises a slot evaluation device.

### FIELD OF TECHNOLOGY

The present disclosure relates to a system and method for the concurrent operation of at least two wireless link paths. The present disclosure also relates to a device for the concurrent operation of at least two wireless link paths.

### BACKGROUND

Methods for the operation of wireless link paths are known. They include, for example, DECT, WDCT, HomeRF, WLAN, HyperLan2 and Bluetooth. Of the large number of known methods, the DECT (Digital Enhanced Cordless Telecommunications) standard has stood the test for many years, as it is a sophisticated and powerful technology which can be used both for voice and for data transmission. From the DECT standard has emerged, among others, the WDCT (Worldwide Digital Cordless Telecommunications) standard. The WDCT standard uses carrier frequencies in the free ISM band (2.4 GHz). In recent years, the Bluetooth standard has also emerged, promising a link between different devices, for example between a computer and a digital camera, that can be implemented at low cost. The Bluetooth standard also has its carrier frequency in the ISM band.

Whereas in the past the simultaneous presence of devices having a transmission facility compliant with the WDCT standard and of devices compliant with the Bluetooth standard were the exception, their concurrent operation is nowadays encountered increasingly. Since, however, both standards function in the 2.4 GHz band and both systems use frequency hopping, concurrent operation regularly leads to considerable impairments. Due to data packets overlapping one another at the same time on the same frequency, highly disruptive crackling arises in voice links, the transmission rate is reduced in data links because of the need for error corrections and/or the effective reach of the link path is diminished.

It is known from the prior art, where there is a plurality of wireless path links, for the respective frequency range to be filtered out and thus for only the frequency range assigned to a certain method to be evaluated. However, as the WDCT standard and the Bluetooth standard operate in essentially congruent frequency ranges, this HF filtering is not practicable. It is also known for two transmission methods to be separated by means of a TDMA (Time Division Multiple Access) coordination. For this, however, the following condition has to be met: A digital transmission method transmits the data by means of a sequence of frames which can in turn be subdivided into sub-frames and comprise a plurality of slots. By means of the slots, points in time are defined at which slot events can occur, i.e. the transmission of a data packet can take place. The duration of time which is taken up by a slot or by a frame is called a slot cycle or frame cycle. A TDMA method can as a rule only be used if the frame and slot cycles match. If slot cycles or frame cycles do not match, or neither slot cycles nor frame cycles match—as is, for example, the case with WDCT and Bluetooth, the known TDMA method does not achieve any satisfactory results.

From the document IEEE INFOCOM 2002 “Coexistence Mechanisms for Interference Mitigation between IEEE 802.11 WLANs and Bluetooth”, a method is disclosed for reducing interferences, wherein if interferences occur, these are detected by the WLAN and, depending on the detection, the WLAN packet concerned is postponed (postponed transmission) or also shortened (shortened transmission) in such a way that it fits between two Bluetooth time slots.

### SUMMARY

A system, method and a device is disclosed for the concurrent operation of at least two wireless link paths having at least two digital transmission methods whose carrier frequencies at least overlap, which method and device ensure an interference-reduced or interference-free operation of link paths.

In an exemplary method for the concurrent operation of at least two wireless link paths, at least one first link path has a first digital transmission method and at least one second link path has a second digital transmission method, and the carrier frequencies of said transmission methods lie in frequency bands that at least overlap. Also, the transmission methods transmit, in defined frame and slot cycles, data in a sequence of frames subdivided into a plurality of slots, the frame and/or slot cycles of the transmission methods having different durations, the first transmission method being isochronous and signal fields of the link paths overlapping in such a manner that at the site of at least one receiver of a link path signals originating from two different transmission methods are received. The slot events of the second transmission method are dynamically distributed to the slots available in the second transmission method depending on slot events of the first transmission method. Here, slot events are distributed, i.e. data packets are assigned to certain slots, in such a way that the slot events of the second transmission method take place at the times at which the first isochronous transmission method has no slot event. The dynamic adaptation makes it possible for an interruption-free coexistence of the two transmission methods to be achieved, despite the different frame and/or slot cycles. In particular, it is not therefore necessary to modify the first transmission method. This method will be referred to below as “slot hopping”. Particularly where frame and slot cycles are different, the coexistence of two fundamentally different transmission methods, particularly in relation to their temporal course, can thus be achieved. It should be pointed out at this point that the proposed method can in principle also be used with line-bound transmission paths, if two signals that overlap in their carrier frequency ranges are to be routed on one line. In addition, the method can also be deployed with a non-isochronous first transmission method, additional precautions then having to be taken in order to determine the slots actually available for slot events.

The dynamic distribution of slot events may advantageously be defined as a deterministic slot-hopping sequence. In order for transmission along the transmission path to function with the proposed slot hopping method, the slots of a frame on which the transmitter will place the slot events must be known to the respective receiver. This basically means that the transmitter has to signal the respective slots to the receiver. If a deterministic slot-hopping sequence, i.e. a sequence which can be determined with the aid of at least one parameter without naming all the individual elements of the sequence, is now used, then it suffices to transmit the at least one stated parameter (for example a start value) to the receiver and to have the slot-hopping sequence determined by the receiver. In this way, there is no longer a need to signal each slot and the performance of the transmission path is enhanced.

It is preferred if the slot-hopping sequence is derived from an identity code used in the second transmission method. If a slot-hopping sequence which can be determined in this manner is used, it suffices for the identity code to be transmitted between transmitter and receiver so that the receiver can determine automatically the slot-hopping sequence used by the transmitter. As a result, the volume of data which has to be transmitted to the receiver to determine the respective slots is kept low.

In one exemplary embodiment, the slot-hopping sequence is established by means of a pseudo-random sequence. The pseudo-random sequence is a numerical sequence which, starting from a start value, consists of seemingly randomly chosen, though precisely determined, numerals. It offers a simple facility for forming a slot-hopping sequence and making known the entire sequence using its start value. Furthermore, the impact of a systematic fault can in this way be reduced and eavesdropping security improved.

The dynamic distribution of slot events is advantageously chosen in such a manner that a plurality of mutually independent links can exist along a first and/or second link path. Firstly, this means that in the second transmission method if possible all the slots in which a slot event of the second transmission method would not overlap with a slot event of the first transmission method are held available for use in a link. Secondly, this means that when a further link is established along the first link path, the slot-hopping sequence is adapted such that the newly added link can function undisturbed. If, when optimizing the maximum possible number of links, it transpires that occasional overlapping of slot events will occur, then it can be weighed up whether to suppress a slot event in the second transmission method that would otherwise collide in order not to affect the first link path.

It is advantageous if the slot-hopping sequence is used in a time-shifted manner for each link. In this way the individual links can be separated from one another in a particularly simple manner.

A first exemplary transmission method is a Bluetooth transmission method. In anticipation of devices being manufactured at low cost, Bluetooth has found its way into various products, especially for end customers. It is now possible for Bluetooth to coexist with a second transmission method and advantageously no interventions are therefore necessary in existing Bluetooth devices.

The second exemplary transmission method is a TDMA-based transmission method, in particular a WDCT transmission method. The WDCT standard—as a prominent example of a TDMA-based standard—has found wide acceptance because of its performance capability, which goes hand in hand with a very high number of WDCT devices in operation. As disclosed herein, the first transmission method can now be operated alongside a WDCT transmission method. The slot events of a WDCT link which were previously arranged at equidistant intervals now lie time-dependently, i.e. individually for each frame, on different positions which in each case are not being used by the first transmission method.

A dummy bearer transmitted according to the second transmission method is advantageously determined by a receiver through evaluation of slot events on at least two receive slots. If the receiver receives an identity message from a transmitter, the receiver initially has no information about which slot-hopping sequence is being used by the transmitter and at which position in the slot-hopping sequence the transmitter currently finds itself. Since the dummy bearer sent by the transmitter is also transmitted using the slot-hopping method, the receiver can now determine the dummy bearer by evaluating the at least two receive slots, that is the receive slots are evaluated until such time as the slot-hopping sequence of the dummy bearer has been detected. At the same time, an increase in the receive slots evaluated by the receiver results as a rule in determination of the slot-hopping sequence of the dummy bearer being accelerated.

The individual slots advantageously each run through independent frequency-hopping sequences. This simplifies detection of the slot-hopping sequence.

In another exemplary embodiment, the second transmission method is a WDCT transmission method with 10 slots per frame. In this way, the proposed method can be implemented particularly cost-effectively.

It is advantageous if the Bluetooth transmission method transmits at least some data as HV3 data packets. If HV3 data packets are transmitted along the Bluetooth link path-which in practice might very frequently be the case—then a particularly reliable parallel operation of the first and second transmission methods is produced.

The present disclosure also relates to a transmit device and a receiver for the concurrent operation of the previously described link paths, having respectively a slot allocation device and a slot evaluation device which implement a method in accordance with the features described hereinabove.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 shows an exemplary operating sequence of two simultaneous links by means of WDCT and Bluetooth,

FIG. 2a shows an exemplary slot adaptation of a mobile terminal if a dummy bearer is transmitted by a base station in slot 0,

FIG. 2b shows an exemplary slot adaptation of a mobile terminal if a dummy bearer is transmitted by a base station in slot 4, and

FIG. 3 shows an exemplary structure of a link path comprising a transmit device and a receive device.

### DETAILED DESCRIPTION

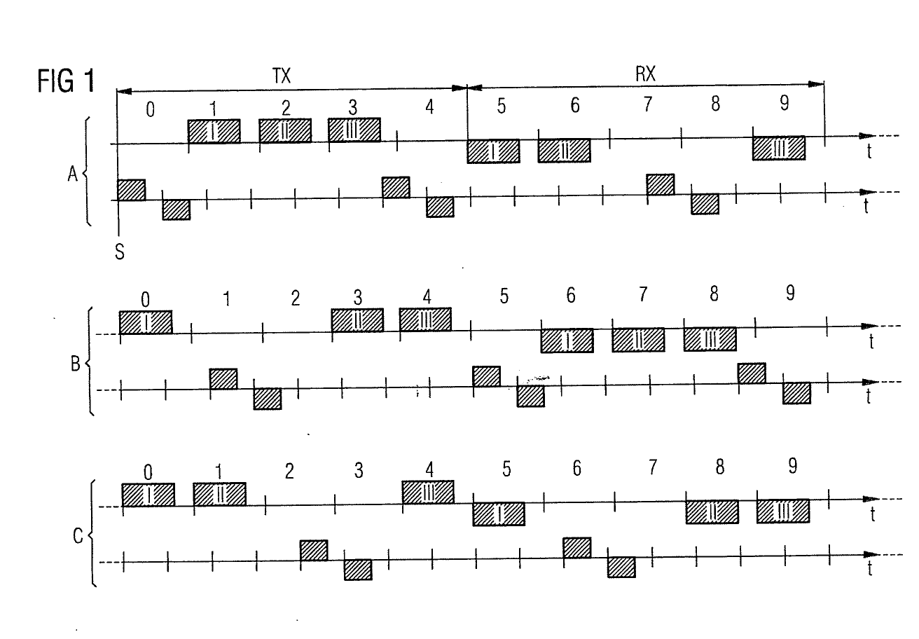

FIG. 1 shows the temporal course of a signal transmission along an exemplary WDCT link path, the link path being overlaid concurrently by a Bluetooth link path. The course is represented here for a duration of three frames of the WDCT method. In each area A, B or C, respectively, the WDCT signal is represented in the upper part and the Bluetooth signal in the lower part. Each area A, B, C represents a frame which extends over a total duration of 10 ms and is subdivided into a total of 10 slots of 1 ms in width. Each frame is subdivided into two sub-frames, namely a sub-frame TX in transmit mode and a sub-frame RX in receive mode. The sub-frame TX extends from slot 0 to slot 4, the sub-frame RX from slot 5 to slot 9. Where a slot of the WDCT method is used for a slot event, then this is indicated by a rectangle. The link within the WDCT link path for which the slot event is used is marked on the inside of the rectangle with a Roman numeral. (In this example, three links I, II and III are used simultaneously.) The signal shape on the Bluetooth link path will not be explained in detail here as it is a known standard here which will be viewed as a fixed standard.

Firstly, the virtual start time S is determined which represents the beginning of a Bluetooth frame. The determination of this start time S can be determined by means of an evaluation of the Bluetooth signal shape. If a synchronization signal of the Bluetooth transmitter is available, then this signal can be used directly for synchronizing the WDCT link with the Bluetooth link. This is possible in a particularly simple manner if WDCT transmitter and Bluetooth transmitter are integrated in one housing or on one board. The signal shape occurring after the start time S can be seen directly from FIG. 1. Only a few remarks will therefore be made with regard to area A. At start time S, a first Bluetooth slot event begins, which is then followed by a second Bluetooth slot event. The end of the second Bluetooth slot event coincides approximately with the start of slot 1 (WDCT). To be precise, a minimal time gap of about 9 μs is produced here. The pause occurring now until the start of the third Bluetooth slot event is used by the WDCT link in order to transmit data packets within slots 1, 2 and 3 to the links I, II and III. The end of the WDCT slot event in slot 3 then coincides approximately with the start of the third Bluetooth slot event just mentioned. In sub-frame RX, the WDCT link uses the slots 5, 6 and 9 in order to receive data with regard to the stated links. Slots 7 and 8 remain unused since considerable overlapping with Bluetooth slot events would arise here. The dynamic distribution continues, in an adapted form in each case, in the two frames that follow (area B and C), the signal shape appearing again from the end of the third frame as from the start time S.

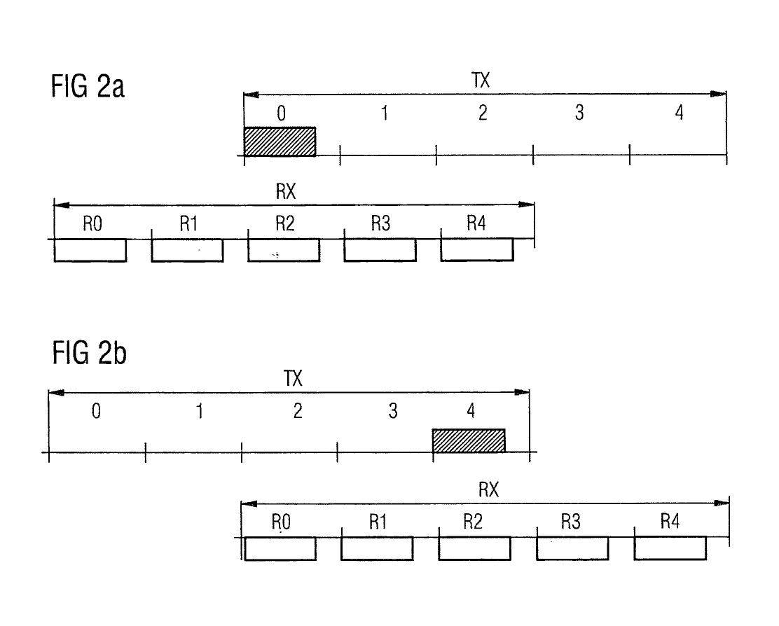

FIGS. 2a and 2b show an exemplary slot adaptation which is used in the situation just outlined in order in a simple manner to determine the slot-hopping sequence used by a transmitter, for example a base station, by means of which sequence the dummy bearer is also transmitted. Once a receiver, such as a mobile terminal, has received an identity message, it is then necessary to determine the dummy bearer from the transmitted signal sequence. The receiver knows at this point in time only that the dummy bearer is located in a slot of the sub-frame TX, i.e. in one of the slots 0 to 4. In order to determine now the slot-hopping sequence of the dummy bearer, the receiver opens in this example five receive slots (R0 to R4) and checks for each slot the receipt of a dummy bearer. In the case shown in FIG. 2, the dummy bearer is transmitted by the transmitter in slot 0. The receiver then defines the slot in which the dummy bearer was received as slot 2. As a result, it is possible that on both sides of slot 2 two further receive slots are available. In the case shown in FIG. 2b, the dummy bearer is transmitted by the transmitter in slot 4. Here, too, the receiver defines the slot 2 again so that on both sides of the slot in which the dummy bearer was received, two further receive slots are available respectively.

The complete synchronization procedure which enables a data transmission will now be explained with the aid of another example. It is assumed here that a mobile terminal aims to synchronize with a base station. For this, the following steps are performed:

a) The mobile terminal receives a base station identity message.

b) After temporal synchronization of the slots of the mobile terminal with the base station, the mobile terminal first sets R2 (slot 2) as receive slot.

c) For the next two frames, all five receive slots are opened in the mobile terminal. The slot-hopping sequence that is used ensures that the dummy bearer which is transmitted by the base station can be a maximum of ±2 slots away from the R2 slot. (It should be noted that other base station slots are not received by the mobile terminal due to the simultaneously applied slot-specific frequency-hopping method.)

d) By means of the information obtained from the five receive slots, the slot position of the base station dummy bearer is determined for each frame. From this, it can then be determined which slot-hopping sequence the base station is using.

e) In this way, the temporal positioning of frames of the mobile terminal can now be corrected such that the frames of the mobile terminal run synchronously with the frames of the base station.

As the slot-hopping sequence is now known to the mobile terminal and the frames lie synchronously with the base station, the previously described exchange of data along the WDCT link path can start.

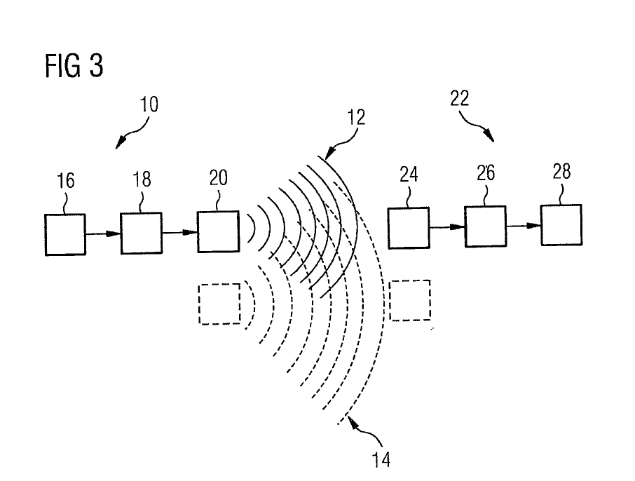

Turning to FIG. 3, the illustration shows a transmit device 10 for the concurrent operation of at least two wireless link paths 12, 14, the first link path 12 being operated in accordance with the WDCT transmission method and the second link path 14 being operated in accordance with the Bluetooth transmission method. The transmit device 10 comprises a data processing device 16, a slot allocation device 18 and a transmitter 20. In the data processing device 16, data is processed in accordance with the WDCT standard and forwarded to the slot allocation device 18. In the slot allocation device 18, the data packets are distributed to certain slots in accordance with the previously described method. The data packets arranged thus are forwarded to the transmitter 20 and transmitted by means of the first link path 12 to the receive device 22. The receive device 22 comprises a receiver 24, a slot evaluation device 26 and a data processing device 28. Once the data packets transmitted by the first link path 12 have been received by the receiver 24, they go to the slot evaluation device 26. Here, the slots predetermined by the slot-hopping sequence are evaluated and their data packets assigned to a certain link. The data edited in this manner is then forwarded by the slot evaluation device 26 to the data processing device 28 where it is processed further in a known manner in accordance with the WDCT standard.

The transmit device 10 or receive device 22 described here represents a cost-effective solution which necessitates no additional costs through additional devices (for example, an HF filter). Moreover, a robust algorithm is used which can be implemented without continuous signaling of the slot-hopping sequence.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-14. (canceled)

15. A method for simultaneously operating at least two wireless link paths, having respectively different first and second transmission protocols, wherein at least some of carrier frequencies of the at least two wireless link paths overlap, the method comprising the steps of:
receiving a first transmission from a first of the at least two wireless link paths, said first transmission comprising first data in a sequence of frames subdivided into a plurality of slots, wherein the first data has defined frame and slot cycles, and wherein the first transmission protocol is isochronous;
receiving a second transmission from a second of the at least two wireless link paths simultaneously with the first transmission, said second transmission comprising second data in a sequence of frames subdivided into a plurality of slots, wherein the second data has defined frame and slot cycles, and wherein at least one of the frame and slot cycles of the second transmission is different from the first transmission; and
dynamically distributing slot events of the second transmission to the slots available in the second transmission protocol depending on the slot events of the first transmission protocol, said dynamic distribution being implemented using a deterministic slot-hopping sequence established by a pseudo-random sequence.

16. The method according to claim 15, wherein the slot-hopping sequence is derived from an identity code used in the second transmission protocol.

17. The method according to claim 15, wherein the dynamic distribution is performed so that a plurality of mutually-independent links exist between at least the first and second link paths.

18. The method according to claim 17, wherein the slot-hopping sequence occurs in a time-shifted manner for each link.

19. The method according to claim 15, wherein the first transmission protocol is a Bluetooth protocol.

20. The method according to claim 19, wherein the Bluetooth transmission transmits at least some data as HTML Viewer 3 (HV3) data packets.

21. The method according to claim 15, wherein the second transmission protocol is a TDMA-based protocol.

22. The method according to claim 21, wherein the TDMA-based protocol is a Worldwide Digital Cordless Telecommunications (WDCT) transmission with 10 slots per frame.

23. The method according to claim 15, wherein a dummy bearer received from the second transmission is determined using an evaluation of slot events on at least two receive slots.

24. The method according to claim 15, wherein individual slots each run through independent frequency-hopping sequences.

25. A transmission device for simultaneously operating on at least two wireless link paths, having respectively different first and second transmission protocols, wherein at least some of carrier frequencies of the at least two wireless link paths overlap, comprising:
parts for transmitting a first transmission from a first of the at least two wireless link paths, said first transmission comprising first data in a sequence of frames subdivided into a plurality of slots, wherein the first data has defined frame and slot cycles, and wherein the first transmission protocol is isochronous;
parts for transmitting a second transmission from a second of the at least two wireless link paths simultaneously with the first transmission, said second transmission comprising second data in a sequence of frames subdivided into a plurality of slots, wherein the second data has defined frame and slot cycles, and wherein at least one of the frame and slot cycles of the second transmission is different from the first transmission; and
a slot allocation device that dynamically distributes slot events of the second transmission to the slots available in the second transmission protocol depending on the slot events of the first transmission protocol, said dynamic distribution being implemented using a deterministic slot-hopping sequence established by a pseudo-random sequence.

26. A receiving device for simultaneously operating on at least two wireless link paths, having respectively different first and second transmission protocols, wherein at least some of carrier frequencies of the at least two wireless link paths overlap, comprising:
parts for receiving a first transmission from a first of the at least two wireless link paths, said first transmission comprising first data in a sequence of frames subdivided into a plurality of slots, wherein the first data has defined frame and slot cycles, and wherein the first transmission protocol is isochronous;
parts for receiving a second transmission from a second of the at least two wireless link paths simultaneously with the first transmission, said second transmission comprising second data in a sequence of frames subdivided into a plurality of slots, wherein the second data has defined frame and slot cycles, and wherein at least one of the frame and slot cycles of the second transmission is different from the first transmission; and
a slot evaluation device that dynamically distributes slot events of the second transmission to the slots available in the second transmission protocol depending on the slot events of the first transmission protocol, said dynamic distribution being implemented using a deterministic slot-hopping sequence established by a pseudo-random sequence.
